(19) United States
(12) Patent Application Publication
(10) Pub. No.: US 2008/0123504 A1
(43) Pub. Date: May 29, 2008

(54) Optical Recording Meduim and Method for Producing the Same

(76) Inventors: Takeshi Kakuta, Kanagawa (JP); Hiroaki Takano, Kanagawa (JP)

Correspondence Address: TAIYO CORPORATION, 401 HOLLAND LANE, #407, ALEXANDRIA, VA, 22314, US

(21) Appl. No.: 11/660,317

(22) PCT Filed: Sep. 29, 2005
(86) PCT No.: PCT/JP05/18499

§ 371 Date: Feb. 15, 2007

(30) Foreign Application Priority Data
Sep. 30, 2004 (JP) 2004-288564

(51) Int. Cl. G11B 3/74

(52) U.S. Cl. 369/94

(57) ABSTRACT

The present invention provides an optical information recording medium having, a substrate, and on one side of the substrate, in the following order, a recording layer, a first adhesive layer, a first transparent sheet, and a hard coating layer, and on the other side, in the following order, a second adhesive layer, a second transparent sheet, and a label layer, wherein a ratio of the humidity expansion coefficient of layer (b) to that of layer (b) for each of the following (1) to (3) is in a range of 0.8 to 1.2:
(1) (a) first adhesive layer, and (b) second adhesive layer;
(2) (a) first transparent sheet, and (b) second transparent sheet; and
(3) (a) hard coating layer, and (b) label layer.

### TECHNICAL FIELD

The present invention relates to an optical information recording medium, in which information can be recorded and from which information can be reproduced with laser light having a particular wavelength, and to a method for producing the same.

### BACKGROUND ART

Heretofore, an optical information recording medium (an optical disc) in which information can be recorded only once with laser light has been known. The optical disc is also called a recordable CD (what is called a CD-R). In the typical configuration thereof, a recording layer including an organic dye, a reflective layer made of a metal such as gold, and a resinous protective layer (a transparent sheet) are laminated in this order on a transparent disc-shaped substrate. Information is recorded in the CD-R by irradiating the CD-R with near-infrared laser light (generally, laser light having a wavelength of approximately 780 nm). The irradiated area of the recording layer absorbs the light and the temperature of the area therefore locally rises. Thereby, physical or chemical change (e.g. generation of pits) in the area occurs, and the optical characteristics of the area are therefore changed to record information in the area. On the other hand, the information is read (reproduced) by irradiating the CD-R with laser light having the same wavelength as the laser light for recording, and detecting the difference in reflectance between areas of the recording layer whose optical characteristics have been changed (recorded areas) and areas of the recording layer whose optical characteristics have not been changed (non-recorded areas).

Recently, an optical information recording medium with higher recording density has been demanded. In response to such a demand, an optical disc referred to as a recordable digital versatile disc (so-called DVD-R) was proposed (see, for example, “Nikkei New Media”, supplementary volume “DVD”, published in 1995). The DVD-R has a configuration in which two discs, each usually having a transparent disc-shaped substrate with a guide groove (i.e., pre-groove) for tracking of irradiated laser light which guide groove has a groove width (0.74 to 0.8 μm) equal to or narrower than the half of that for a CD-R, a recording layer including an organic dye, a reflective layer, and a protective layer in this order, are bonded together with the recording layers located inside, or a configuration in which the disc described above and a disc-shaped protective substrate having the same shape as the disc are bonded together with the recording layer located inside. Information is recorded in and reproduced from the DVD-R by irradiating the DVD-R with visible laser light (usually, laser light whose wavelength is in the range of 630 nm to 680 nm), and thereby recording with recording density higher than that of CD-R can be realized.

Recently, networks such as the Internet and hi-vision television sets have been rapidly spreading. In addition, a broadcast for high definition television (HDTV) has been begun. Under such circumstances, a recording media with large capacity in which image information can be easily and inexpensively recorded is in demand. Hitherto, the DVD-R sufficiently serves as a recording medium with large capacity. However, considering an increasing demand for larger capacity and higher density, it is necessary to develop a recording medium that can meet such a demand. Therefore, a recording medium that can achieve higher density recording with light having a wavelength shorter than that of recording light for DVD-Rs and has larger capacity has been under development.

In general, an optical information recording medium with higher density can be achieved by narrowing the beam spot. The narrowing the beam spot results from shortening the wavelength of the laser light used for the recording and reproduction and increasing the NA of the objective lens. Recently, development has been rapidly shifting from red light-emitting semiconductor lasers, whose wavelengths are 680 nm, 650 nm and 635 nm, to blue-violet light-emitting semiconductor lasers with a wavelength in the range of 400 nm to 500 nm (herein after, referred to as blue-violet laser), which enables ultra-high density recording, and optical information recording media corresponding thereto have been also developed. In particular, since the introduction of the blue-violet laser, development of an optical recording system that makes use of the blue-violet laser and a high NA pickup is being studied, and a recordable optical information recording medium having a phase change recording layer and an optical recording system for the same have been already publicized as a DVR-Blue system (see, for example, “ISOM2000”, pp. 210-211). In addition, a DVR-Blue disc, which is a recordable optical information recording medium including an organic dye, and in which information is recorded and from which the information is reproduced with the blue-violet laser, has also been made public (see, for example, “ISOM2001”, pp. 218-219). Thus, for the object of increasing recording density, achievements have been obtained to some extent owing to these optical information recording media.

In the optical information recording medium for use in an optical recording system utilizing the blue-violet laser and the high NA pickup, a transparent sheet having a surface from which incident laser light enters the medium is thinned in order to focus the high-NA objective lens at the time that blue-violet laser radiation is irradiated to the recording layer (see, for example, Japanese Patent No. 3,431,6129). As the transparent sheet, for instance, a thin film made from a material similar to that of the substrate is utilized, and is bonded to the recording layer using an adhesive or a pressure-sensitive adhesive. The total thickness of the transparent sheet and an adhesive layer or a pressure-sensitive adhesive layer formed by hardening the adhesive or the pressure-sensitive adhesive is generally about 100 μm. However, the thickness is optimized depending on the wavelength of the laser irradiated or the NA.

Due to the thinning of the transparent sheet, unbalance in thickness of the substrate and the transparent sheet occurs in the optical information recording medium mentioned above when the recording layer is taken as the center. This signifies that, for example, when the optical information recording medium is placed in an environment in which the humidity rapidly increases, the substrate absorbs a large amount of moisture and the transparent sheet absorbs a small amount of moisture to result in a conspicuous difference in shrinkage and expansion rates of both layers. Thus, if there is an unbalance in thickness of the substrate and the transparent sheet and shrinkage and expansion rates of both layers differ, warpage becomes great in a case where these is a rapid change in temperature or humidity, thereby resulting in a deterioration of recording and reproducing characteristics.

As a means for solving the above problems, there is a measure of balancing expansion and shrinking by forming an identical transparent sheet on the surface of the other side of the substrate. However, in a case where a reflective layer, which is a hydrophobic layer, is present, the reflective layer cannot be incorporated at the center in the thickness direction. Hence, this cannot provide a complete solution to the problem because moisture absorption on both sides becomes unbalanced.

On the other hand, since the optical information recording medium described above is used together with a high NA pickup, the distance between the pickup and the transparent sheet is small. Therefore, when a fluctuation in the surface of the optical information recording medium occurs, this brings the pickup and the transparent sheet into contact with each other, and the transparent sheet tends to be damaged. In order to overcome this problem, formation of a damage preventive layer or a hard coating layer, which is provided to prevent the transparent sheet from being damaged, on the transparent sheet by spin coating or vacuum deposition was proposed (for instance, see Japanese Patent Application Laid-Open (JP-A) No. 2000-67468 and Japanese Patent No. 3,112,467). However, since the damage preventive layer or hard coating layer is provided sheet-wise on the transparent sheet, there has been a problem of low productivity.

Accordingly, there is a need for an optical information recording medium having low possibility of generating warping and for a method for efficiently producing the optical information recording medium.

### DISCLOSURE OF INVENTION

The above need is satisfied by the following invention.

A first aspect of the invention provides an optical information recording medium having, a substrate, and on one side of the substrate, in the following order, a recording layer, a first adhesive layer, a first transparent sheet, and a hard coating layer, and on the other side, in the following order, a second adhesive layer, a second transparent sheet, and a label layer, wherein a ratio of the humidity expansion coefficient of layer (b) to that of layer (b) for each of the following (1) to (3) is in a range of 0.8 to 1.2:

(1) (a) first adhesive layer, and (b) second adhesive layer;
(2) (a) first transparent sheet, and (b) second transparent sheet; and
(3) (a) hard coating layer, and (b) label layer.

Further, a second aspect of the invention provides an optical information recording medium having: a substrate, and on one side of the substrate, in the following order, a hydrophobic layer, a recording layer, a first adhesive layer, and a first transparent sheet, and on the other side, in the following order, a second adhesive layer and a second transparent sheet, wherein a ratio of the humidity expansion coefficient of said first transparent sheet to the humidity expansion coefficient of said substrate, and a ratio of the humidity expansion coefficient of said second transparent sheet to the humidity expansion coefficient of said substrate are both 5 or greater.

Furthermore, a third aspect of the invention provides a method for producing an optical information recording medium including: forming a hard coating layer and a first adhesive layer on a first web of a transparent sheet serving as a first transparent sheet; punching the first web out into a disc shape; forming a label layer and a second adhesive layer on a second web of a transparent sheet serving as a second transparent sheet; and punching the second web out into a disc shape, wherein the optical information recording medium has a substrate, and on one side of the substrate, in the following order, a recording layer, the first adhesive layer, the first transparent sheet, and the hard coating layer, and on the other side, in the following order, the second adhesive layer, the second transparent sheet, and the label layer.

The invention can provide an optical information recording medium having low possibility of generating warping and for a method for efficiently producing the optical information recording medium.

### BRIEF DESCRIPTION OF DRAWINGS

FIG. 1 is a cross sectional view showing schematically the layer configuration of an optical information recording medium according to a first embodiment of the invention; and

FIG. 2 is a cross sectional view showing schematically the layer configuration of an optical information recording medium according to a second embodiment of the invention.

### BEST MODE FOR CARRYING OUT THE INVENTION

The invention will be explained in detail below.

An optical information recording medium according to a first embodiment of the invention has, a substrate, and on one side of the substrate, in the following order, a recording layer, a first adhesive layer, a first transparent sheet, and a hard coating layer, and on the other side of the substrate, in the following order, a second adhesive layer, a second transparent sheet, and a label layer, and the ratio of the humidity expansion coefficient of layer (b) to that of layer (b) for each of the following (1) to (3) is in a range of 0.8 to 1.2:

(1) (a) first adhesive layer, and (b) second adhesive layer;
(2) (a) first transparent sheet, and (b) second transparent sheet; and
(3) (a) hard coating layer, and (b) label layer.

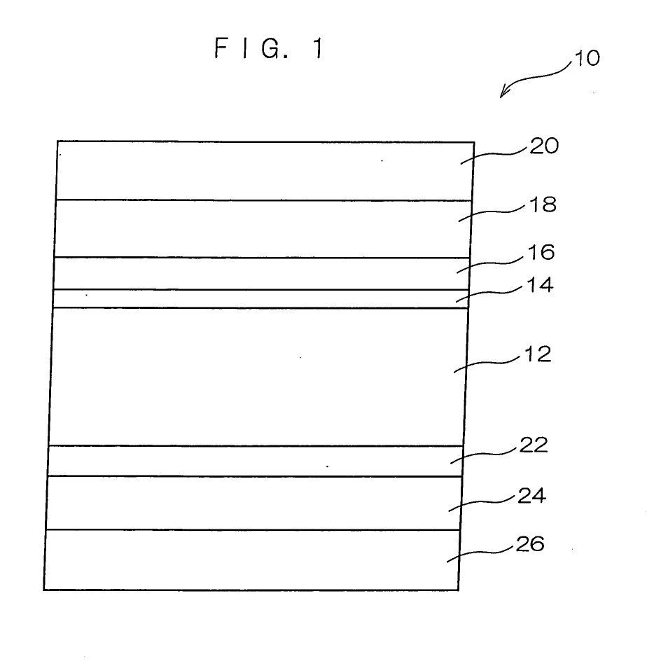

The layer configuration of the optical information recording medium according to the first embodiment of the invention is schematically shown in FIG. 1. The optical information recording medium 10 shown in FIG. 1 has a substrate 12, and on one side (upper side in FIG. 1) of the substrate 12, in the following order, a recording layer 14, a first adhesive layer 16, a first transparent sheet 18, and a hard coating layer 20, and on the other side (lower side in FIG. 1) of the substrate 12, in the following order, a second adhesive layer 22, a second transparent sheet 24, and a label layer 26. In other words, the optical information recording medium 10 has a configuration in which a laminated structure of the second adhesive layer 22, the second transparent sheet 24, and the label layer 26 is disposed on the side of the substrate 12 which side is opposite to the substrate side having another laminated structure from the substrate 12 to the hard coating layer 20. As described later, the recording layer 14 is much thinner than each of the other layers. Specifically, the recording layer has a thickness of several tens nm, whereas each of the other layers has a thickness of several tens μm. The layers (a) and (b) in each of (1) to (3) are disposed approximately symmetrically with respect to the substrate taken as the center of symmetry. The ratio of humidity expansion coefficients of each combination of layers disposed approximately symmetrically being in the range of 0.8 to 1.2 signifies that the humidity expansion coefficients of the layers are approximately equal, and that the layers located at approximately symmetrical positions show similar expansion due to absorbing moisture from the exterior. Accordingly, since there is little unbalance in humidity expansion coefficient between one side of the medium and the other side which are symmetrically with respect to the substrate, warping due to an unbalanced laminated layer configuration can be prevented from occurring.

In the invention, the ratio of the humidity expansion coefficient of layer (b) to that of layer (a) for each of the aforementioned (1) to (3) is in the range of 0.8 to 1.2, as described above. When the ratio is out of the range, the difference in humidity expansion coefficient between the layers causes warping. The ratio is more preferably 0.9 to 1.1, and theoretically, most preferably 1.

In the invention, the humidity expansion coefficient is a numerical value obtained from the following measurement. Specifically, an object to be measured, which is processed into a film, is cut into a rectangle having a longer side of 250 mm, and a shorter side of 50 mm, and two holes each having a diameter of 5 mm are formed therein at an interval of 200 mm. The object is then attached to a pin gauge. The length of the object is measured after placing it under a controlled humidity of 10% at 25° C. for 3 hours, and the length is measured again after placing it under a controlled humidity of 80% at 25° C. for 3 hours. The humidity coefficient is obtained from the change in length.

In the aforementioned (1) to (3), the material of the layer (a) is preferably the same as that of the layer (b). For instance, this can be achieved by making (a) the first adhesive layer and (b) the second adhesive layer in (1) of the same material, making (a) the first transparent sheet and (b) the second transparent sheet in (2) of the same material, and making (a) the hard coating layer and (b) the label layer in (3) with, for example, an ultra violet-curable acrylic resin. The material of each of these layers will be described later.

Preferably, the thickness of the layer (a) and the thickness of the layer (b) in the aforementioned (1) to (3) are approximately the same. Laminating such layers makes the thickness of layers disposed on one side of the substrate and that of layers disposed on the other side of the substrate substantially the same, which can prevent warping due to unbalance between the thickness of layers on one side of a substrate and that of layers on the other side from occurring. Specific thickness of each layer will be described later.

An optical information recording medium of a second embodiment of the invention has a substrate, and on one side of the substrate, in the following order, a hydrophobic layer, a recording layer, a first adhesive layer, and a first transparent sheet, and on the other side, in the following order, a second adhesive layer and a second transparent sheet, and the ratio of the humidity expansion coefficient of the first transparent sheet to the humidity expansion coefficient of the substrate, and the ratio of the humidity expansion coefficient of the second transparent sheet to the humidity expansion coefficient of the substrate are both 5 or greater.

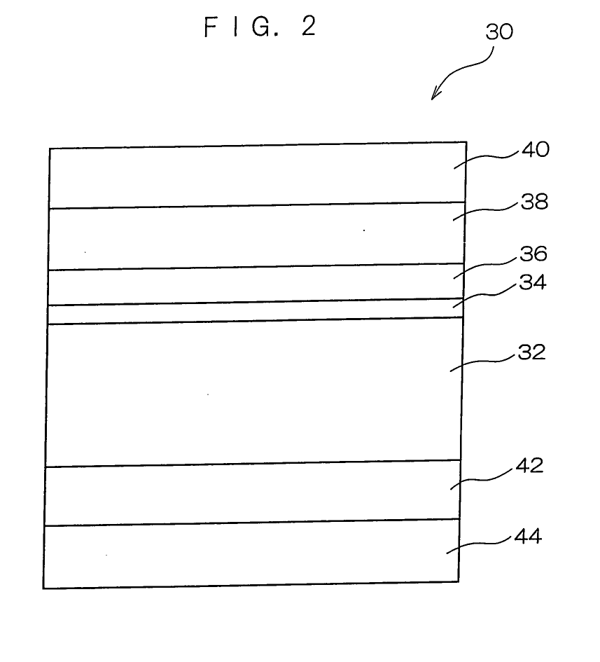

The layer configuration of the optical information recording medium according to the second embodiment of the invention is schematically shown in FIG. 2. The optical information recording medium 30 shown in FIG. 2 has a substrate 32, and on one side (upper side in FIG. 2) of the substrate 32, in the following order, a hydrophobic layer (reflective layer) 34, a recording layer 36, a first adhesive layer 38, and a first transparent sheet 40, and on the other side (lower side in FIG. 2) of the substrate 32, in the following order, a second adhesive layer 42 and a second transparent sheet 44. In other words, the optical information recording medium 30 has a configuration in which a laminated structure of the second adhesive layer 42 and the second transparent sheet 44 is disposed on the side of the substrate 32 which side is opposite to the substrate side having another laminated structure from the substrate 32 to the first transparent sheet 40.

In the layer configuration of this optical information recording medium according to the second embodiment of the invention, the reflective layer, which is a hydrophobic layer, is not the center in the thickness direction. However, by setting the ratio of the humidity expansion coefficient of the first transparent sheet to that of the substrate and the ratio of the humidity expansion coefficient of the second transparent sheet to that of the substrate to a value of 5 or greater, preferably 10 or higher (upper limit of 50), that is, by making each of the first and second transparent sheets sufficiently thicker than the substrate, expansion of the transparent sheets, which are located at the outer side of the reflective layer, is dominant to expansion of the substrate, balancing the thickness of layers on one side of the substrate with that of layers on the other side and thereby reducing the possibility of generating warping.

When the adhesive layer has strong adhesive force (pressure-sensitive adhesive force) and is thin in the optical information recording medium according to the second embodiment of the invention, shrinkage of the adhesive layer may accompany shrinkage of the transparent sheet, which may destroy the deformed region of the pressure-adhesive layer, which is in contact with the recording layer, in the recording portion and displace pits. In order to avoid this, it is preferable to lower the adhesive force (pressure-sensitive adhesive force) of the adhesive layer and to thicken the adhesive layer. That is, it is preferable that the adhesive layer is made of a pressure-sensitive adhesive having a glass transition temperature (Tg) of 0° C. or lower and adhesive force of 30 N/25 mm or lower and is 10 μm or more in thickness. Setting the physical properties of the pressure-sensitive adhesive and the thickness of the adhesive layer within these ranges can avoid pit displacement.

The glass transition temperature of the pressure-sensitive adhesive is preferably 0° C. or lower, and more preferably −20 to −50° C. Moreover, the pressure-sensitive adhesive force is preferably 30 N/25 mm or lower, and more preferably 25 to 10 N/25 mm. Furthermore, the thickness of the adhesive layer is preferably 10 μm or more, and more preferably 10 to 20 μm.

Hereinafter, each of the layers of the optical information recording medium of the invention, and methods for forming the respective layers and a method for producing the optical information recording medium will be described sequentially.

### Substrate

The substrate in the invention can be made of any of materials used as substrate materials in conventional optical information recording media.

Specific examples of the material include glass; polycarbonate; acrylic resins such as polymethyl methacrylate; vinyl chloride resins such as polyvinyl chloride and vinyl chloride copolymer; epoxy resins; amorphous polyolefins; polyesters; and metals such as aluminum. A mixture of two or more of these materials can be used, if necessary.

From the viewpoints of moisture resistance, dimensional stability, and low costs, the substrate is preferably made of a thermoplastic resin such as amorphous polyolefin or polycarbonate, and more preferably made of polycarbonate.

When such a resin is used as the substrate material, the substrate can be manufactured by injection-molding.

It is necessary that the thickness of the substrate is in the range of 0.7 to 2 mm. The thickness of the substrate is preferably in the range of 0.9 to 1.6 mm, and more preferably in the range of 1.0 to 1.3 mm.

The substrate has a tracking guide groove or convexities and concavities (pre-groove) for representing information such as address signals on one surface thereof on which one surface a recording layer is provided. In order to achieve higher recording density, the pre-groove is needed to have a track pitch narrower than the track pitch of a CD-R or a DVD-R. For example, when the optical information recording medium of the invention is used as a medium suitable for a blue-violet laser, the pre-groove preferably has sizes within the following ranges.

The upper limit of the track pitch of the pre-groove is preferably 500 nm or less, more preferably 420 nm or less, and still more preferably 370 nm or less, and most preferably 330 nm or less. Furthermore, the lower limit is preferably 50 nm or more, more preferably 100 nm or more, still more preferably 200 nm or more, and most preferably 260 nm or more.

The upper limit of the width (half breadth) of the pre-groove is preferably 250 nm or less, more preferably 200 nm or less, still more preferably 170 nm or less, and most preferably 150 nm or less. Furthermore, the lower limit is preferably 23 nm or more, more preferably 50 nm or more, still more preferably 80 nm or more, and most preferably 100 nm or more.

The upper limit of the (groove) depth of the pre-groove is preferably 150 nm or less, more preferably 100 nm or less, still more preferably 70 nm or less, and most preferably 50 nm or less. Furthermore, the lower limit is preferably 5 nm or more, more preferably 10 nm or more, still more preferably 20 nm or more, and most preferably 28 nm or more.

The upper limit of the angle of the pre-groove is preferably 80° or less, more preferably 70° or less, still more preferably 60° or less, and most preferably 50° or less. Furthermore, the lower limit of the angle of the pre-groove is preferably 20° or more, more preferably 30° or more, and still more preferably 40° or more.

Each of the upper limits for each of the track pitch, width, depth and angle can be arbitrarily combined with each of the lower limits for the corresponding one of these.

These values of the pre-groove can be measured with an atomic force microscope (AFM). When D represents the depth of the groove and the surface of a substrate on which the pre-groove has not been formed is taken as a reference, the above-described angle of the pre-groove is defined by a line connecting an inclined portion of the pre-groove which inclined portion is at a depth of D/10 from the surface with another inclined portion of the pre-groove which inclined portion is at a depth D/10 from the deepest portion of the groove, and the bottom surface of the groove.

When the optical information recording medium of the invention is a ROM-type optical information medium, pits representing predetermined information and the pre-groove are simultaneously formed.

In order to manufacture a substrate having a pre-groove having the above sizes (and pits), it is necessary that a stamper used during injection molding is formed by highly precise mastering. In order to achieve the above-mentioned groove shape, it is preferable that cutting by a DUV laser (whose wavelength is 330 nm or less in the deep ultra violet range) or electron beam (EB) is carried out in the mastering.

On the other hand, when a UV laser or visible laser is used, it is difficult to carry out excellent mastering which enables formation of a groove having the above-described sizes.

In order to improve planarity and adhesive force, it is preferred to form an undercoat layer on the surface of the substrate.

Examples of the material of the undercoat layer include high molecular substances such as polymethyl methacrylate, acrylic acid-methacrylic acid copolymer, styrene-maleic anhydride copolymer, polyvinyl alcohol, N-methylol acrylamide, styrene-vinyltoluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, polyethylene, polypropylene and polycarbonate; and surface modifiers such as a silane coupling agent.

The undercoat layer can be formed by dissolving or dispersing the material mentioned above in a proper solvent to prepare a coating liquid, followed by applying the coating liquid onto the surface of a substrate by a coating method such as a spin coating method, a dip coating method, or an extrusion coating method. The thickness of the undercoat layer is generally in the range of 0.005 to 20 μm, and preferably in the range of 0.01 to 10 μm.

### Recording Layer

The recording layer in the invention is preferably a dye-type one containing a dye as a recording substance, but is not limited to such a layer. The recording layer may also be an inorganic recordable-type (a write once type), a phase change-type, a photo-magnetic-type or a ROM-type one.

Accordingly, the recording material contained in the recording layer can be an organic compound such as a dye or a phase change metal compound.

Among these, the dye-type recording layer that in which information can be recorded only once with laser light is preferable. Such a dye-type recording layer preferably contains a dye having absorption in a recording wavelength region. The dye can be a cyanine dye, an oxonol dye, a metal complex dye, an azo dye and/or a phthalocyanine dye.

Alternatively, the dye can also be any of dyes disclosed in JP-A Nos. 4-74690, 8-127174, 11-53758, 11-334204, 11-334205, 11-334206, 11-334207, 2000-43423, 2000-108513, and 2000-158818.

The recording layer is formed by dissolving a dye and a binder in an adequate solvent to prepare a coating liquid, coating the coating liquid on a substrate or a reflective layer described later, and drying the resultant coating. At this time, the temperature of a surface on which the coating liquid is coated is preferably in the range of 10 to 40° C. The lower limit of the temperature range is more preferably 15° C. or more, still more preferably 20° C. or more, and most preferably 23° C. or more. Meanwhile, the upper limit thereof is more preferably 35° C. or less, still more preferably 30° C. or less, and most preferably 27° C. or less. When the temperature is in the range mentioned above, coating unevenness and coating failure can be inhibited from occurring and the thickness of the resultant coating film can be uniform.

Each of the upper limits can be arbitrarily combined with each of the lower limits.

The recording layer may be either a single layer or multi layers. When the recording layer has a multi-layered configuration, the recording layer can be formed by carrying out coating plural times.

The concentration of the dye in the coating liquid is generally in the range of 0.01 to 15 mass percent, preferably in the range of 0.1 to 10 mass percent, more preferably in the range of 0.5 to 5 mass percent, and most preferably in the range of 0.5 to 3 mass percent.

Examples of the solvent for the coating liquid include esters such as butyl acetate, ethyl lactate and cellosolve acetate; ketones such as methyl ethyl ketone, cyclohexanone, and methyl isobutyl ketone; chlorinated hydrocarbons such as dichloromethane, 1,2-dichloroethane and chloroform; amides such as dimethylformamide; hydrocarbons such as methylcyclohexane; ethers such as tetra hydrofuran, ethyl ether, and dioxane; alcohols such as ethanol, n-propanol, iso-propanol, n-buthanol, and diacetone alcohol; fluorinated solvents such as 2,2,3,3-tetra fluoropropanol; and glycol ethers such as ethylene glycol monomethyl ether, ethylene glycol monoethyl ether and propylene glycol monomethyl ether.

One of these solvents can be used alone or two or more thereof can be used together in consideration of the solubility of the dye used. Furthermore, the coating liquid may contain at least one additive such as an antioxidant, a UV absorbent, a plasticizer and a lubricant in accordance with the purpose.

The coating method can be a spray method, a spin coating method, a dip method, a roll coating method, a blade coating method, a doctor roll method or a screen printing method.

The temperature of the coating liquid during the coating is preferably in the range of 23 to 50° C., more preferably in the range of 24 to 40° C., and still more preferably in the range of 23 to 50° C.

The upper limit of the thickness of the portion of the recording layer thus formed which portion is disposed on the groove (the protruded portion of the substrate) is preferably 300 nm or less, more preferably 250 nm or less, still more preferably 200 nm or less, and most preferably 180 nm or less. The lower limit thereof is preferably 30 nm or more, more preferably 50 nm or more, still more preferably 70 nm or more, and most preferably 90 nm or more.

Furthermore, the upper limit of the thickness of the portion of the recording layer thus formed which portion is disposed on a land (the concave portion of the substrate) is preferably 400 nm or less, more preferably 300 nm or less, and still more preferably 250 nm or less. The lower limit thereof is preferably 70 nm or more, more preferably 90 nm or more, and still more preferably 110 nm or more.

In addition, the lower limit of the ratio of the thickness of the portion of the recording layer on the groove to that on the land is preferably 0.4 or more, more preferably 0.5 or more, still more preferably 0.6 or more, and most preferably 0.7 or more. The upper limit thereof is preferably less than 1, more preferably 0.9 or less, still more preferably 0.85 or less, and most preferably 0.8 or less.

Each of the upper limits can be arbitrarily combined with each of the lower limits.

When the coating liquid contains a binder, examples of the binder include naturally occurring organic polymers such as gelatin, cellulose derivatives, dextran, rosin and rubber; and synthetic organic polymers such as hydrocarbon resins such as polyethylene, polypropylene, polystylene and polyisobutylene, vinyl resins such as polyvinyl chloride, polyvinylidene chloride, and vinylchloride-vinyl acetate copolymer, acrylic resins such as polymethyl acrylate and polymethyl methacrylate, polyvinyl alcohol, chlorinated polyethylene, epoxy resin, butyral resin, rubber derivatives, and initial condensates of thermosetting resins such as phenol-formaldehyde resin. When the recording layer contains a binder, the amount (mass) of the binder used is generally 0.01 to 50 times the amount (mass) of the dye, and more preferably 0.1 to 5 times the amount of the dye.

In order to improve light resistance of the recording layer, the recording layer may contain an anti-fading agent.

The anti-fading agent is generally a singlet oxygen quencher. The singlet oxygen quencher may be any of those described in publications such as patent specifications.

Specific examples thereof include those described in JP-A Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995, and 4-25492, Japanese Patent Application Publication (JP-B) Nos. 1-38680 and 6-26028; German Patent No. 350399; and the journal of the Chemical Society of Japan published in October (1992), p. 1141.

The amount of the anti-fading agent such as the singlet oxygen quencher is generally in the range of 0.1 to 50 mass percent, preferably in the range of 0.5 to 45 mass percent, more preferably in the range of 3 to 40 mass percent and most preferably in the range of 5 to 25 mass percent with respect to the amount of the dye.

Coating methods using a solvent to prepare a dye-type recording layer have been described above. However, the recording layer can be formed by a film deposition method such as vacuum evaporation, sputtering, or CVD according to the physical properties of the recording substance.

For example, when a phase change metal compound is used as the recording material, it is preferable that the recording layer is formed by any of the above methods. The phase change metal compound can be any one of SbTe, AgSbTe, and InAgSbTe. Transparent sheet (first and second transparent sheets)

Each of the first and second transparent sheets in the invention is bonded to the recording layer or a barrier layer described later or a substrate, with an adhesive layer interposed therebetween.

The transparent sheet used in the invention can be a film made of any transparent material, but is preferably made of polycarbonate; an acrylic resin such as polymethyl methacrylate; a vinyl chloride resin such as polyvinyl chloride or vinyl chloride copolymer; an epoxy resin; amorphous polyolefin; polyester; or cellulose triacetate, and more preferably polycarbonate or cellulose triacetate.

Here, the term “transparent” means having transmittance of 80% or higher with respect to light used for recording and reproducing.

Further, the transparent sheet may contain an additive to such an extent that does not affect the effect of the invention. For example, the transparent sheet may contain a UV absorbent that cuts off light having a wavelength of 400 nm or less and/or a dye that cuts off light having a wavelength of 500 nm or more.

Concerning the physical properties of the surface of the transparent sheet, the surface roughness serving as both the two-dimensional and three-dimensional roughness parameters is preferably 5 nm or less.

From the viewpoint of the degree of condensing of light for recording and reproducing, the birefringence of the transparent sheet is preferably 10 nm or less.

The thickness of the transparent sheet is properly set depending on the wavelength of laser light irradiated for recording and reproducing and the NA. However, in the present invention, the thickness is generally in the range of 0.01 to 0.5 mm, and preferably in the range of 0.05 to 0.12 mm.

The total thickness of the transparent sheet and the layer made of an adhesive is preferably in the range of 0.09 to 0.11 mm, and more preferably in the range of 0.095 to 0.105 mm.

A hard coating layer may be provided on the surface of the transparent sheet from which surface incident light enters the medium so as to prevent the surface from being damaged during manufacturer of the optical information recording medium. Adhesive layer (first and second adhesive layers)

As stated above, the transparent sheet is bonded to the recording or barrier layer or the substrate via a first or a second adhesive layer. An adhesive or a pressure-sensitive adhesive may be used as the material of the adhesive layer. Hereinafter, each of these will be described sequentially.

The adhesive used to bond the transparent sheet to the recording or barrier layer or the substrate is preferably a UV curable resin, an EB curable resin, or a thermosetting resin, and more preferably a UV curable resin.

When a UV curable resin is used as the adhesive, the UV curable resin itself or a coating liquid prepared by dissolving the UV curable resin in an adequate solvent such as methyl ethyl ketone or ethyl acetate may be supplied from a dispenser onto the surface of the barrier or recording layer or the substrate. In order to prevent the thus manufactured optical information recording medium from warping, the UV curable resin of the adhesive layer preferably has a small shrinkage factor at the time of curing. Such a UV curable resin can be SD-640™ manufactured by Dainippon Ink and Chemicals, Incorporated.

Preferably, a predetermined amount of the adhesive is applied onto the bonding surface of the barrier or recording layer or the substrate, a transparent sheet is placed on the resultant adhesive layer, and the adhesive is spread uniformly between the bonding surface and the transparent sheet by spin coating and then cured.

The thickness of the adhesive layer made of such an adhesive is preferably in the range of 0.1 to 100 μm, more preferably in the range of 0.5 to 50 μm, and still more preferably in the range of 10 to 30 μm.

The pressure-sensitive adhesive used to bond the transparent sheet to the recording or barrier layer or the substrate can be an acrylic, rubber, or silicon-containing pressure-sensitive adhesive. From the viewpoints of transparency and durability, the pressure-sensitive adhesive is preferably an acrylic one. The acrylic pressure-sensitive adhesive is preferably one obtained by copolymerizing 2-ethylhexyl acrylate or n-butyl acrylate serving as the main monomer, and a short-chained alkyl acrylate or methacrylate to enhance cohesion, such as methyl acrylate, ethyl acrylate, or methyl methacrylate, and acrylic acid, methacrylic acid, acrylamide derivative, maleic acid, hydroxylethyl acrylate, or glycidyl acrylate which can work as a cross-linking point for a cross-linking agent. The glass transition temperature (Tg) and cross-linking density of the adhesive can be changed by properly controlling the blending ratio and the kinds of the main monomer, the short-chained component, and the component for providing the cross-linking point.

The cross-linking agent used together with the pressure-sensitive adhesive is, for example, an isocyanate one. Examples of the isocyanate cross-linking agent include isocyanates such as tolylenediisocyanate, 4,4′-diphenylmethanediisocyanate, hexamethylenediisocianate, xylylenediisocyanate, naphthylene-1,5-diisocyanate, o-toluidinediisocyanate, isophoronediisocyanate, and triphenylmethanetriisocyanate; products of these isocyanates and polyalcohols; and polyisocyanates produced by condensing these isocyanates. Examples of commercially available products of the isocyanates include CORONATE L, CORONATE HL, CORONATE 2030, CORONATE 2031, MILLIONATE MR and MILLIONATE HTL manufactured by Nippon Polyurethane Industry Co. Ltd.; TAKANATE D-102, TAKENATE D-110N, TAKANATE D-200 and TAKENATE D-202 manufactured by Takeda Pharmaceutical Industries Co., Ltd.; and DESMODULE L, DESMODULE IL, DESMODULE N and DESMODULE HL manufactured by Sumitomo Bayer Urethane Co., Ltd.

A predetermined amount of the pressure-sensitive adhesive may be uniformly applied to the bonding surface of the barrier or recording layer or the substrate, the transparent sheet may be placed on the resultant adhesive layer, and the pressure-sensitive adhesive may be cured. Alternatively, a predetermined amount of the pressure-sensitive adhesive may be applied onto one surface of a transparent sheet to form a pressure-sensitive adhesive coating film, and the coating film may be laminated on the bonding surface, and then cured.

Alternatively, a commercially available pressure-sensitive adhesive film having a layer of the pressure-sensitive adhesive on a transparent sheet can be used.

The thickness of the pressure-sensitive adhesive layer made of the pressure-sensitive adhesive is preferably in the range of 0.1 to 100 μm, more preferably in the range of 0.5 to 50 μm, and still more preferably in the range of 10 to 30 μm.

### Reflective Layer

In order to increase reflectance with respect to laser light or impart a function of improving the recording and reproducing characteristics, a reflective layer is preferably formed between the substrate and the recording layer in the invention. In the second embodiment of the invention, the reflective layer corresponds to the hydrophobic layer. The hydrophobic layer can be a heat-shielding layer, or an optical interference layer, as well as the reflective layer.

The reflective layer can be formed on a substrate by vacuum-evaporating, sputtering or ion-plating a light reflective material having a high reflectance with respect to laser light.

The thickness of the reflective layer is generally in the range of 10 to 300 nm and preferably in the range of 50 to 200 nm.

Further, the reflectance is preferably 70% or higher.

Examples of the light reflective material having a high reflectance include metals and metalloids such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, and stainless steel. One of these light reflective materials may be used alone, or two or more of these may be used together or used as an alloy. The light reflective material is preferably Cr, Ni, Pt, Cu, Ag, Au, Al or stainless steel, more preferably Au, Ag, Al or an alloy thereof, and most preferably Au, Ag or an alloy thereof.

### Hard Coating Layer

The hard coating layer is a layer for preventing the medium from being damaged, and the material thereof is preferably a radiation-curable resin. The radiation-curable resin of the hard coating layer may be any resin curable by radiation irradiation. Specifically, it is preferably a resin having two or more radiation-functional double bonds in the molecule thereof.

For instance, the material can be acrylic ester, acrylamide, methacrylic ester, methacrylamide, an allyl compound, vinyl ether, or vinyl ester. Among them, the material is preferably a multi-functional acyrlate or methacrylate compound.

### Other Layers

The optical information recording medium of the invention may have optional layers in addition to the essential layers mentioned above, so far as the effect of the invention is not impaired. Examples of the optional layers include a barrier layer disposed between the recording layer and the transparent sheet, and an interface layer disposed between the reflective layer and the recording layer.

Each of the essential layers and the optional layers can be a single layer or may have a multi-layered structure.

### Barrier Layer (Intermediate Layer)

In the invention, it is preferable to form a barrier layer between the recording layer and the transparent sheet. The barrier layer is provided to improve the shelf life of the recording layer, strengthen the adhesiveness between the recording layer and the transparent sheet, control reflectance, and control thermal conductivity.

The material of the barrier layer is needed to transmit light for recording and reproducing and can exhibit the above functions, and otherwise it is not limited. The material generally has a low permeability with respect to gas and water, and is preferably a dieletric material.

Specifically, the material is preferably a nitride, oxide, carbide and/or sulfide including Zn, Si, Ti, Te, Sn, Mo, and/or Ge, more preferably ZnS, MoO₂, GeO₂, TeO, SiO₂, TiO₂, ZnO, ZnS—SiO₂, SnO₂ or ZnO—Ga₂O₃, and still more preferably ZnS—SiO₂, SnO₂ or ZnO—Ga₂O₃.

The barrier layer can be formed by a vacuum film deposition method such as vacuum evaporation, DC sputtering, RF sputtering, or ion plating. Among them, it is preferable to use a sputtering method. It is more preferable to conduct RF sputtering.

The thickness of the barrier layer in the invention is preferably in the range of 1 to 200 nm, more preferably in the range of 2 to 100 nm, and still more preferably in the range of 3 to 50 nm.

As mentioned above, the optical information recording medium of the first embodiment of the invention has, on the surface of a substrate which surface is opposite to the surface from which incident light enters the medium, a second adhesive layer, a second transparent sheet, and a label layer, in addition to the substrate, the recording layer, and the transparent sheet. The second adhesive layer and the second transparent sheet are respectively the same as the first adhesive layer and the first transparent sheet. Hereinafter, the label layer will be explained.

### Label Layer

The label layer may be a printing layer of an optical information recording medium which printing layer has printed character and/or image information, and/or a printable layer on which a character and/or an image can be drawn by a user.

Description of the printing layer and the printable layer will be given below.

### —Printing Layer—

The printing layer is a layer on which, for example, the content of the optical information recording medium is printed, and users can easily understand the content of the disc media from this printing layer. Furthermore, improving the design of this printing layer makes it possible to improve the design of the optical information recording medium as a whole.

### —Printable Layer—

The information medium of the invention may have a printable layer including an ink-receiving layer. The printable layer is, for instance, a layer in which an image can be printed with an ink jet printer, and is preferably a layer obtained from an ultra violet-curable resin disclosed in JP-A No. 2002-245671.

In the first embodiment of the invention, the material of the label layer is such that the ratio of the humidity expansion coefficient thereof to that of the hard coating layer is in the range of 0.8 to 1.2. Such a material can be an ink-receiving material in which a pigment or a dye is dispersed in an ultra violet-curable acrylic resin.

### Base Layer

Providing a base layer having high opacity results in diffusivity close to that of paper and therefore improved image quality. In particular, fine color reproducibility can be achieved by providing a white base layer. Highly glossy base layer results in a glossy photograph-like finish, whereas a highly matted base layer leads to a matted photograph-like finish. Various images having different impressions can be formed by using various colors for the base layer. Furthermore, a fluorescent base layer can provide fluorescent image quality. There are no restrictions on a method for forming such a base layer. However, from the viewpoint of productivity, the base layer is preferably formed by screen-printing a radiation-curable resin. The radiation-curable resin is cured by an electromagnetic wave such as ultra violet radiation, electron beam, X-ray, γ-radiation, or infrared radiation, and is preferably cured by ultra violet radiation or electron beam.

Information can be recorded in the optical information recording medium of the invention by irradiating the medium with laser light having a wavelength in the range of 100 to 600 nm from the transparent sheet side, and thereby physically or chemically changing the recording layer.

Recording by irradiating the optical information recording medium having the above configuration of the invention with laser light having an appropriate wavelength can provide good and stable recording and reproducing characteristics.

The lower limit of the wavelength of recording light (wavelength of the laser light) is preferably 200 nm or longer, more preferably 300 nm or longer, and still more preferably 350 nm or longer. The upper limit thereof is preferably 500 nm or shorter, more preferably 450 nm or shorter, and still more preferably 420 nm or shorter.

Each of the upper limits can be arbitrarily combined with each of the lower limits.

Information may be recorded in the groove or land of the optical information recording medium of the invention, but is preferably recorded in the groove.

Furthermore, the laser light having a wavelength in the wavelength region mentioned above can also be used to reproduce the information.

More specifically, information is recorded in the optical information recording medium (recordable type) of the invention and reproduced therefrom in, for example, the following manner.

First, the optical information recoding medium, which is being rotated at a predetermined linear velocity (0.5 to 10 m/sec) or a predetermined constant angular velocity, is irradiated with light for recording, such as blue-violet laser light (having a wavelength of, for example, 405 nm) from the transparent sheet side through an objective lens. The recording layer absorbs the irradiated light and the temperature of the recording layer is locally raised, thereby generating, for example, pits, and changing the optical characteristics of the recording layer to record information in the layer. The information thus recorded can be reproduced by irradiating the optical information recording medium, which is being rotated at a predetermined constant linear velocity, with blue-violet laser light from the transparent sheet side and detecting the reflected light.

A laser light source having a laser emission wavelength of 500 nm or shorter can be blue-violet semiconductor laser having a laser emission wavelength in the range of, for instance, 390 to 415 nm, or a blue-violet SHG laser having a central laser emission wavelength of 425 nm.

In order to increase the recording density, the NA of the objective lens used in a pickup is preferably 0.7 or higher, and more preferably 0.85 or higher.

### <Production Method of Optical Information Recording Medium>

A method for producing an optical information recording medium of the invention is that for producing an optical information recording medium having a substrate, and on one side of the substrate, in the following order, a recording layer, a first adhesive layer, a first transparent sheet, and a hard coating layer, and on the other side, in the following order, a second adhesive layer, a second transparent sheet, and a label layer. The method includes forming the hard coating layer and the first adhesive layer on a first web of a transparent sheet serving as the first transparent sheet; punching the first web out into a disc shape; forming the label layer and the second adhesive layer on a second web of another transparent sheet serving as the second transparent sheet; and punching the second web out into a disc shape. The method of the invention is suitable for production of the optical information recording medium according to the first embodiment of the invention. Since the method for forming a recording layer has been already described, methods for forming the transparent sheet, the hard coating layer and the label layer will be described below.

First, a radiation-curable resin coating liquid is continuously coated onto one side of a transparent sheet web, and the resulting coated film is continuously irradiated with a radiation whose dose is the radiation dose necessary to completely cure the film. Thus, the coated film is cured to form a hard coating layer.

In this step, the transparent sheet web which is rolled is sequentially and continuously unrolled and fed to a predetermined coating region and continuously coated with the radiation-curable resin coating liquid in the region from the front edge to the rear edge so as to form a continuous coated film on one side of the web. Then, the coated film is sequentially and continuously irradiated with radiation at a dose necessary to completely cure the film and then cured to form a hard coating layer. Thereby, the hard coating layer is provided on the entire surface of the transparent sheet.

A cover film (transparent sheet) of the web rolled can be, for instance, a film having a width of 150 mm and a length of 200 m wound around a spindle having a diameter of 150 mm.

The thickness of the cover film is preferably in the range of 0.03 to 0.15 mm, and more preferably in the range of 0.05 to 0.12 mm. The thickness being within this range can facilitate handling and suppress coma aberration.

The radiation used to cure the radiation-curable resin can be electron beam or ultra violet radiation. In the case of ultra violet radiation, the ultra violet-curable resin coating liquid preferably contains a photopolymerization initiator. The photopolymerization initiator is preferably an aromatic ketone. There is no particular restriction on the type of the aromatic ketone. However, the aromatic ketone preferably has a relatively high absorptivity at wavelengths of 254, 313, and 365 nm, which correspond to the luminescent line spectra of a mercury vapor lamp generally used as the light source for ultra violet radiation. Typical examples of the aromatic ketone include acetophenone, benzophenone, benzoin ethyl ether, benzyl methyl ketal, benzyl ethyl ketal, benzoin isobutyl ketone, hydroxydimethyl phenyl ketone, 1-hydroxycyclohexyl phenyl ketone, 2,2-diethoxyacetophenone, and Michler's ketone.

The amount of the aromatic ketone is generally 0.5 to 20 parts by mass, preferably 2 to 15 parts by mass, and more preferably 3 to 10 parts by mass with respect to 100 parts by mass of the ultra violet-curable resin. The ultra violet-curable resin can be a commercially available ultra violet-curable adhesive including an ultra violet-curable resin and a photopolymerization initiator. Such a commercial product can be, for example, DAICURE CELAR SD715 or DAICURE CLEAR SD101 manufactured by Dainippon Ink and Chemicals, Incorporated, TB3042 manufactured by Three Bond Co., Ltd., or KCD805 manufactured by Nippon Kayaku Co., Ltd.

The radiation-curable resin, including commercial products, is coated on the cover film as it is or in the form of a coating liquid prepared by dissolving it into a proper solvent such as methyl ethyl ketone or ethyl acetate. The coating can be carried out by a known coating method. More specifically, the coating method can be a spray method, a roll coating method, a blade coating method, a doctor roll method, or a screen printing method.

When electron beam is used to cure the radiation-curable resin, an electron beam accelerator is used.

The ultra violet radiation light source used to cure the ultra violet-curable resin is a mercury vapor lamp. The mercury vapor lamp is preferably used at 20 to 200 W/cm and a relative velocity between the resin coated film and the mercury vapor lamp of 0.3 to 20 m/min (when the mercury vapor lamp is fixed, the relative velocity corresponds to the transport speed of the resin coated film). At this time, the distance between the ultra violet-curable resin coated film and the mercury vapor lamp is generally 1 to 30 cm.

The electron beam accelerator for use in a radiation irradiation apparatus may be a scanning-type, double scanning-type, or curtain beam-type one. The electron beam accelerator is preferably a curtain beam-type one which is relatively inexpensive and which has high power. As for the properties of the electron beam, the accelerating voltage is generally in the range of 10 to 1000 kV, and preferably 150 to 300 kV, and the absorption dose is generally in the range of 0.5 to 20 Mrad, and preferably 1 to 10 Mrad. When the accelerating voltage is lower than 10 kV, the amount of transmitted energy is insufficient, which may result in insufficient polymerization reaction. On the other hand, when the accelerating voltage is more than 1000 kV, the efficiency of energy used in the polymerization may decrease, which is an economical problem.

In this manner, the hard coating layer is provided on one side of the transparent sheet. In order to easily transport the transparent sheet to the next step described below, a step of rolling the resultant laminated body having the transparent sheet and the hard coating layer may be subsequently conducted. This makes handling of the laminated body easier than that of laminated plates of the same weight and improves the transportability of the laminated body.

### Step of Continuously Providing Pressure-Sensitive Adhesive Layer (Adhesive Layer) on the Other Side of Transparent Sheet

In this step, a pressure-sensitive adhesive layer (adhesive layer) is continuously provided on the other side of the transparent sheet which the other side is opposite to the side having thereon the hard coating layer made in the step of forming a hard coating layer. Methods for providing a pressure-sensitive adhesive layer can be roughly divided into two methods, i.e., a method in which a pressure-sensitive adhesive layer already formed is bonded to the transparent sheet (which is sometimes referred to as “indirect method”), and a method in which a pressure-sensitive adhesive is directly coated on the surface of the transparent sheet and the resulting coating is dried to form a pressure-sensitive adhesive layer (which is sometimes referred to as “direct method”).

In the case of the indirect method, bonding the pressure-sensitive adhesive layer already formed to the transparent sheet can be attained by, for instance, continuously coating a pressure-sensitive adhesive on the surface of a releasable film having the same size as that of the transparent sheet and drying the resultant coating to provide a pressure-sensitive adhesive layer on the entire surface of the releasable film, and then bonding the pressure-sensitive adhesive layer to the transparent sheet. As a result, the pressure-sensitive adhesive layer bonded to the releasable film is provided on the entire of the other side of the transparent sheet.

In the direct method, the transparent sheet, which is rolled, is unrolled and fed to a predetermined coating region, and the pressure-sensitive adhesive is continuously coated on one side of the transparent sheet in the region from the front edge to the rear edge, and the resultant coated film is sequentially dried to provide a pressure-sensitive adhesive on the entire of the other side of the transparent sheet.

In the indirect and direct methods, the coating of the pressure-sensitive adhesive can be conducted by a known coating method. Specifically, the known method can be a spray method, a roll coating method, a blade coating method, a doctor roll method or a screen printing method.

Moreover, the drying can be conducted by heat or air blow.

In the step of forming a pressure-sensitive adhesive layer on the other side of the transparent sheet, a pressure-sensitive adhesive layer is formed on the other side of the transparent sheet, as described. After this step, a step of rolling the resultant laminated body having the transparent sheet, the hard coating layer and the pressure-sensitive adhesive layer may be subsequently conducted to easily transport the laminated body to the next step described below. When such a step is carried out, a releasable film is preferably bonded to the surface of the pressure-sensitive adhesive layer in order to prevent adhesion between the hard coating layer of one laminated body and the pressure-sensitive adhesive layer of another laminated body. As described above, the laminated body already having a releasable film may be obtained in the case of the indirect method. In the case of the direct method, it is preferred to conduct a step of bonding a releasable film to the surface of the pressure-sensitive adhesive layer after the pressure-sensitive adhesive layer is formed on the surface of the transparent sheet.

Examples of the releasable film to be bonded to the surface of the pressure-sensitive adhesive layer include a polyethylene film, a polyethylene terephthalate film, a polyethylene naphthalate film, a polycarbonate film, and a triacetate cellulose film.

Step of punching transparent sheet having thereon hard coating layer and pressure-sensitive adhesive layer into disc shape, followed by irradiating hard coating layer with radiation for complete curing

In this step, the transparent sheet having thereon the hard coating layer and the pressure-sensitive adhesive layer is punched out into a disc shape having a predetermined size, i.e., a size the same as that of the substrate.

When the step of rolling the transparent sheet having thereon the hard coating layer and the pressure-sensitive adhesive layer to improve the transportability of the laminated body is conducted, the transparent sheet may be unrolled, made flat and then continuously punched out into discs having the same size as that of the substrate with a cut punch.

Subsequently, the remainder of the transparent sheet having thereon the hard coating layer and the pressure-sensitive adhesive layer other than punched out discs can be rolled again, whereby wastes occurring during the punching can be easily collected.

When a releasable film is disposed on the surface of the pressure-sensitive adhesive layer at the time that the transparent sheet having thereon the hard coating layer and the pressure-sensitive adhesive layer is punched out into a disc shape, the three layers, i.e., the hard coating layer, the transparent sheet and the pressure-sensitive adhesive layer may be punched out without punching the releasable film and the portion of the three layers other than the punched-out disc-shaped portions may be removed. As a result, the punched-out portions remain on the releasable film. The releasable film having thereon the punched-out portions may be rolled.

Then, the punched-out disc-shaped portions of the transparent sheet having thereon the hard coating layer and the pressure-sensitive adhesive layer remaining on the releasable film are irradiated with radiation to completely cure the hard coating layer.

By completely curing the radiation-curable resin in this step, the effect of preventing damage of the medium which effect the hard coating layer is required to have can be attained.

The production method of the optical information recording medium of the invention has been described above, but the invention is not limited by the method. For instance, the step of providing a pressure-sensitive adhesive layer on the surface of the transparent sheet and the step of providing a hard coating layer on the other surface of the transparent sheet may be carried out continuously in this order or in an opposite order or simultaneously with the same apparatus.

The production method of the optical information recording medium of the invention has much more improved productivity than a production method in which a hard coating layer is sheet-wise applied by a spin coating method.

### EXAMPLES

The invention will be described more specifically by referring to examples, but the present invention is not limited thereto.

### Example 1

### Production of Optical Information Recording Medium

A substrate obtained by injection-molding a polycarbonate resin (PANLITE AD5503 manufactured by Teijin Limited), having a thickness of 1.1 mm and a diameter of 120 mm and having thereon a spiral groove having a depth of 100 nm, a width of 120 nm, and a track pitch of 320 nm was prepared.

Twenty grams of ORASOL BLUE GN (a phthalocyanine dye available from Ciba Specialty Chemicals) was added to one liter of 2,2,3,3-tetra fluoroporpanol and dissolved therein with ultrasonic waves for 2 hours to prepare a coating liquid for forming a recording layer. Subsequently, the thus prepared coating liquid was applied to the groove-formed surface of the substrate, which was being rotated, by a spin coating method at 23° C. and 50% RH, while the rotation speed of the substrate was changed from 300 to 4000 rpm. The substrate on which the resultant coating was formed was stored at 23° C. and 50% RH for 1 to 4 hours. Thus, a recording layer having a thickness of 100 nm was obtained.

### <Production of Transparent Sheet Having Hard Coating Layer>

[Step (a) in which an ultra violet curable resin coating liquid is continuously applied to on one side of a rolled transparent sheet web, and the resultant coated film is irradiated and cured with an ultra violet radiation whose dose is 50 to 95% of the ultra violet radiation dose necessary to completely cure the coated film, providing a hard coating layer]

A rolled transparent sheet (a polycarbonate film, PURE-ACE, manufactured by Teijin, and having a thickness of 75 μm and a releasable film on one side thereof) was sequentially and continuously unrolled and fed to a predetermined coating region from the front edge to the rear edge thereof. In the region, the previously provided releasable film was removed from the transparent sheet, and an ultra violet-curable resin coating liquid (ultra violet-curable resin, DAICURE CLEAR SD-715, manufactured by Dainippon Ink and Chemicals, Incorporated) was continuously applied to the surface of the transparent sheet from which surface the releasable film had been removed, from the front edge to the rear edge so as to form a coated film. Then, the coated film was sequentially and continuously irradiated and cured with radiations to form a hard coating layer. Thereafter, the transparent sheet (first transparent sheet) having provided thereon the hard coating layer was rolled.

Here, in irradiating the ultra violet radiation in this step (a), the distance between the coated film and a high-pressure mercury vapor lamp was set to 25 cm. At this time, the air in the irradiated region was purged with N₂ (O₂ concentration of 5% or lower). Furthermore, the transparent sheet having the coated film formed thereon was transported at a speed of 2 m/min.

### [Step (b) of continuously providing pressure-sensitive adhesive layer on the other side of transparent sheet]

A pressure-sensitive adhesive coating liquid A was prepared by mixing an acrylic copolymer (solvent: a mixture of ethyl acetate and toluene at a ratio of 1/1) with an isocyanate cross-linking agent (solvent: a mixture of ethyl acetate and toluene at a ratio of 1/1) at a mass ratio of 100:1. The pressure-sensitive adhesive coating liquid had a glass transition temperature (Tg) of 30° C. and pressure-sensitive adhesive force of 20 N/25 mm.

A pressure-sensitive adhesive layer (first adhesive layer) obtained from the thus prepared pressure-sensitive adhesive coating liquid A was formed on the surface of a releasable film (an indirect method) as follows. A rolled polyethylene releasable film was sequentially and continuously unrolled and transported, and the pressure-sensitive adhesive coating liquid A was coated on the surface of the releasable film. Subsequently, the resulting product was dried at 100° C. in a drying region. Thus, a pressure-sensitive adhesive layer having a dry thickness of 15 μm was formed on the releasable film.

Thereafter, the pressure-sensitive adhesive layer formed on the releasable film was bonded to the surface of the transparent sheet which surface was opposite to the surface having thereon the hard coating layer. Then, a first laminated body having the releasable film, the pressure-sensitive adhesive layer, the transparent sheet, and the hard coating layer in that order was rolled, and the first laminated body rolled was stored at 23° C. and 50% RH for 72 hours.

### <Manufacturing of Transparent Sheet for Label Layer>

A laminated body (second laminated body) for a label layer having a transparent sheet, a pressure-sensitive adhesive layer and a releasable film in that order and serving as a second transparent sheet and a second adhesive layer was produced in the same manner as in <Production of transparent sheet having hard coating layer>, except that a hard coating layer was not formed.

The first laminated body was punched out into a disc shape (first disc). Also, the second laminated body was punched out into a disc shape (second disc). The releasable film was peeled off from the first disc. The remaining body was pressed against and bonded to the recording layer formed on the substrate with a roller so that the recording layer faced the pressure-sensitive adhesive layer of the first disc. The releasable film was peeled off from the second disc. Thereafter, the pressure-sensitive adhesive layer of the second disc was pressed against and bonded to the surface of the substrate which surface was opposite to the substrate surface having thereon the recording layer with a roller. A resin paint prepared by adding a binder, a viscosity controlling agent, and a dye to an ultra violet-curable resin containing an urethane acrylate was applied to the surface of the second transparent sheet by screen printing to form a layer having a thickness of 10 μm, and the layer was cured with ultra violet radiation to form a label layer. Thus, an optical information recording medium of Example 1 was obtained.

### Comparative Example 1

An optical information recording medium of Comparative Example 1 was prepared in the same manner as in Example 1, except that a second laminated body for a label layer (second transparent sheet and second adhesive layer) was not prepared.

### Comparative Example 2

An optical information recording medium of Comparative Example 2 was prepared in the same manner as in Example 1, except that, in “Production of transparent sheet having hard coating layer”, an UV adhesive (SD640 manufactured by Dainippon Ink and Chemicals, Incorporated) was coated by spin coating in place of the pressure-sensitive adhesive.

### Comparative Example 3

An optical information recording medium of Comparative Example 3 was prepared in the same manner as in Example 1, except that a hard coating layer was not formed in “Production of transparent sheet having hard coating layer”.

### Comparative Example 4

An optical information recording medium of Comparative Example 4 was prepared in the same manner as in Example 1, except that a TAC Film (FUJITAC manufactured by Fuji Photo Film Co., Ltd.) was used in place of the first transparent sheet.

The humidity expansion coefficients of the layers of the optical information recording media of Example 1 and Comparative Examples 1 to 4 are shown in Table 1. The humidity expansion coefficients were measured by the aforementioned method.

TABLE 1

| | | | Comparative | Comparative | Comparative | Comparative |
|---|---|---|---|---|---|---|
| | | Example 1 | Example 1 | Example 2 | Example 3 | Example 4 |
| Humidity | (a) First adhesive layer | 0.003 | 0.01 | 0.056 | 0.003 | 0.003 |
| Expansion | (%/% RH) | | | | | |
| Coefficient | (b) Second adhesive | 0.003 | None | 0.003 | 0.003 | 0.003 |
| | layer (%/% RH) | | | | | |
| | (b)/(a) | 1 | — | 0.05 | 1 | 1 |
| | (a) First transparent | 0.002 | 0.002 | 0.002 | 0.002 | 0.066 |
| | sheet (%/% RH) | | | | | |
| | (b) Second transparent | 0.002 | None | 0.002 | 0.002 | 0.002 |
| | sheet (%/% RH) | | | | | |
| | (b)/(a) | 1 | — | 1 | 1 | 0.03 |
| | (a) Hard coating layer | 0.066 | 0.66 | 0.066 | None | 0.066 |
| | (%/% RH) | | | | | |
| | (b) Label layer | 0.06 | 0.06 | 0.06 | 0.06 | 0.06 |
| | (%/% RH) | | | | | |
| | (b)/(a) | 0.91 | 0.91 | 0.91 | — | 0.91 |
| Radial Tilt (°) | Initial | 0.15 | 0.3 | 0.25 | 0.22 | 0.56 |
| | After sudden change | 0.18 | 0.78 | 0.6 | 0.52 | 0.71 |
| | Difference | 0.03 | 0.48 | 0.35 | 0.3 | 0.24 |

### Example 2

### Production of Optical Information Recording Medium

### Substrate

A substrate obtained by injection-molding a polycarbonate resin, having a thickness of 1.1 mm, an outer diameter of 120 mm and an inner diameter (diameter of central hole) of 15 mm, and having thereon a spiral groove having a track pitch of 320 nm, a width of 107 nm, and a depth of 35 nm was prepared.

### Formation of Reflective Layer

An APC reflective layer (98.1 mass % of Ag, 0.9 mass % of Pd, and 1.0 mass % of Cu) serving as a vacuum deposition layer and having a thickness of 100 nm was formed on the pre-groove-formed surface of the substrate with CUBE manufactured by Unaxis in an argon atmosphere by DC sputtering. The thickness of the reflective layer was controlled by controlling the sputtering time.

### Formation of Recording Layer

Two grams of dye A represented by the following chemical formula was added to and dissolved in 100 ml of 2,2,3,3-tetra fluoropropanol to prepare a dye-containing coating solution. Then, the thus prepared dye-containing coating solution was applied to the reflective layer formed on the substrate, which was being rotated, at 23° C. and 50% RH by a spin coating method, while the rotation speed of the substrate was changed from 300 to 4000 rpm. The resultant was stored at 23° C. and 50% RH for 1 hour to form a recording layer. The portion of the recording layer which portion was disposed on the groove had a thickness of 140 nm and the portion of the recording layer which portion was disposed on the land had a thickness of 190 nm.

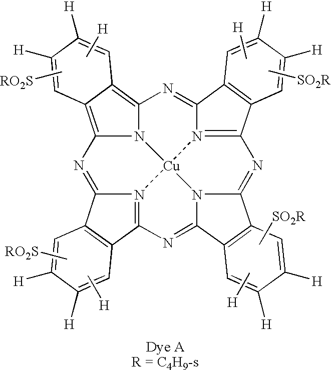

After the recording layer was formed, the resultant was subjected to annealing treatment in a clean oven. In the annealing treatment, substrates on which reflective and recording layers were formed in the same manner as the above were supported by vertical stack poles, spaced apart from each other with spacers. The annealing treatment was carried out at 80° C. for one hour.

### Adhesion of Transparent Sheet

Two laminated bodies (one having a first transparent sheet, a first pressure-sensitive adhesive layer and a releasable film and the other having a second transparent sheet, a second pressure-sensitive adhesive layer and a releasable film) were prepared in the same manner as in the step “Production of transparent sheet having hard coating layer” of Example 1, except that a hard coating layer was not formed, and that the transparent sheet was replaced with a TAC film (manufactured by Fuji Photo Film Co., Ltd.).

The releasable film was peeled off from the laminated body having the first transparent sheet, the first pressure-sensitive adhesive layer and the releasable film. Thereafter, the remaining body was placed on the recording layer, with the recording layer brought into contact with the first pressure-sensitive adhesive layer. Thereafter, the body was pressed against and bonded to the recording layer with a pressing member. Next, the releasable film was peeled off from the other laminated body. Thereafter, the remaining body was placed on the surface of the substrate which surface was opposite to the substrate surface having thereon the recording layer, with the second pressure-sensitive adhesive layer brought into contact with the substrate. Then, the body was pressed against and bonded to the substrate with a pressing member.

An optical information recording medium of Example 2 was produced through the above steps, which were carried out at 25° C. and 45% RH.

### Comparative Example 5

An optical information recording medium of Comparative Example 5 was prepared in the same manner as in Example 2, except that the two transparent sheets (first and second transparent sheets) were replaced with two polycarbonate films (PURE-ACE manufactured by Teijin Limited).

### Comparative Example 6

An optical information recording medium of Comparative Example 6 was prepared in the manner as in Example 2, except that the second transparent sheet was replaced with a polycarbonate film (PURE-ACE manufactured by Teijin Limited).

The humidity expansion coefficients of the substrate and the first and second transparent sheets of each of the optical information recording media of Example 2 and Comparative Examples 5 to 6 and the ratio of the humidity expansion coefficient of the first or second transparent sheet to that of the substrate are shown in Table 2.

TABLE 2

| | | | Com- | Com- |
|---|---|---|---|---|
| | | | parative | parative |
| | | Example 2 | Example 5 | Example 6 |
| Humidity | Substrate (x) | 0.002 | 0.002 | 0.002 |
| Expansion | First transparent sheet | 0.066 | 0.002 | 0.066 |
| Coefficient | (y) | | | |
| | Second transparent | 0.066 | 0.002 | 0.002 |
| | sheet (z) | | | |
| | Value of ratio (y/x) | 33 | 1 | 33 |
| | Value of ratio (z/x) | 33 | 1 | 1 |
| Radial Tilt | Initial | 0.14 | 0.16 | 0.58 |
| (°) | After sudden change | 0.2 | 0.48 | 0.8 |
| | Difference | 0.06 | 0.32 | 0.32 |

### <Evaluation of Optical Information Recording Medium>

### (1) Measurement of Radial Tilt (r-Tilt) Value and Evaluation of Degree of Warping

The optical information recording media obtained by the methods mentioned above were stored at 25° C. and 45% RH for 48 hours, and the degree of warping of each of the optical information recording medium as a whole was evaluated by measuring the inclination (radial tilt value) of each medium in the radial direction. The radial tilt value was measured with DLD 4000 (manufactured by Japan EM Co., Ltd). The measured results for Example 1 and Comparative Examples 1-4 are shown in Table 1, and those for Example 2 and Comparative Examples 5 and 6 are shown in Table 2. In Tables 1 and 2, the values are denoted as initial values.

The optical information recording media obtained by the methods mentioned above were stored at 25° C. and 45% RH for 48 hours, and subsequently stored at 25° C. and 90% RH for 48 hours. Thereafter, they were placed in an environment of 25° C. and 45% RH. The radial tilt values of these media were repeatedly measured in the above manner every 30 minutes for 24 hours. The maximum radial tilt value of each of the media of Example 1 and Comparative Examples 1 to 4 is shown in Table 1, and that of each of the media of Example 2 and Comparative Examples 5 to 6 is shown in Table 2. In Tables 1 and 2, the maximum radial tilt values are denoted as data after sudden change.

From the results shown Tables 1 and 2, it has confirmed that the difference between the initial radial tilt value and the radial tilt value after sudden change of each of the optical information recording media of Examples 1 and 2 is smaller than that of each of the optical information recording media of Comparative Examples 1 to 6.

On the other hand, it is clear that the degree of warping of each of the optical information recording media of Comparative Examples 1 to 6 is considerably influenced by storage environment. This is because the front and back surfaces of each of these media have different degrees of expansion with respect to moisture.

1. An optical information recording medium comprising, a substrate, and on one side of the substrate, in the following order, a recording layer, a first adhesive layer, a first transparent sheet, and a hard coating layer, and on the other side, in the following order, a second adhesive layer, a second transparent sheet, and a label layer, wherein a ratio (b/a) of the humidity expansion coefficient of layer (b) to that of layer (a) for each of the following (1) to (3) is in a range of 0.8 to 1.2:
(1) (a) first adhesive layer, and (b) second adhesive layer;
(2) (a) first transparent sheet, and (b) second transparent sheet; and
(3) (a) hard coating layer, and (b) label layer; and wherein each of the first adhesive layer and the second adhesive layer is made of a pressure-sensitive adhesive and has a thickness of 10 μm or more.

2. The optical information recording medium as claimed in claim 1, wherein the material of the layer (a) is the same material of the layer (b) in each of said (1) to (3).

3. The optical information recording medium as claimed in claim 1, wherein the thickness of the layer (a) is approximately the same as the thickness of the layer (b) in each of said (1) to (3).

4. The optical information recording medium as claimed in claim 2, wherein the thickness of the layer (a) is approximately the same as the thickness of the layer (b) in each of said (1) to (3).

5. The optical information recording medium comprising: a substrate, and on one side of the substrate, in the following order, a hydrophobic layer, a recording layer, a first adhesive layer, and a first transparent sheet, and on the other side, in the following order, a second adhesive layer and a second transparent sheet, wherein a ratio of the humidity expansion coefficient of said first transparent sheet to the humidity expansion coefficient of said substrate, and a ratio of the humidity expansion coefficient of said second transparent sheet to the humidity expansion coefficient of said substrate are both 5 or greater.

6. The optical information recording medium as claimed in claim 5, wherein the hydrophobic layer is a reflective layer.

7. The optical information recording medium as claimed in claim 5, wherein said first adhesive layer and/or said second adhesive layer comprises a pressure-sensitive adhesive having a glass transition temperature of 0° C. or lower and adhesive force of 30 N/25 mm or lower, and has a thickness of 10 μm or more.

8. The optical information recording medium as claimed in claim 6, wherein said first adhesive layer and/or said second adhesive layer comprises a pressure-sensitive adhesive having a glass transition temperature of 0° C. or lower and adhesive force of 30 N/25 mm or lower, and has a thickness of 10 μm or more.

9. A method for producing an optical information recording medium comprising:
forming a hard coating layer and a first adhesive layer on a first web of a transparent sheet serving as a first transparent sheet;
punching the first web out into a disc shape;
forming a label layer and a second adhesive layer on a second web of a transparent sheet serving as a second transparent sheet; and
punching the second web out into a disc shape,
wherein the optical information recording medium comprises a substrate, and on one side of the substrate, in the following order, a recording layer, the first adhesive layer, the first transparent sheet, and the hard coating layer, and on the other side, in the following order, the second adhesive layer, the second transparent sheet, and the label layer, and each of the first adhesive layer and the second adhesive layer is made of a pressure-sensitive adhesive and has a thickness of 10 μm or more.

10. The optical information recording medium as claimed in claim 1, wherein each of the first adhesive layer and the second adhesive layer is made of a pressure-sensitive adhesive and has a thickness of 10 to 30 μm.

11. The optical information recording medium as claimed in claim 1, wherein each of the first transparent sheet and the second transparent sheet is made of cellulose triacetate.

12. The method as claimed in claim 9, wherein each of the first adhesive layer and the second adhesive layer is made of a pressure-sensitive adhesive and has a thickness of 10 to 30 μm.

13. The method as claimed in claim 9, wherein each of the first transparent sheet and the second transparent sheet is made of cellulose triacetate.
